(19) United States
(12) Patent Application Publication
(10) Pub. No.: US 2014/0114721 A1
(43) Pub. Date: Apr. 24, 2014

(54) Method for creating and valuing derivative instruments which are linked to a casinos or a basket of casinos win rate

(71) Applicant: David Clayton Peister, Las Vegas, NV (US)

(72) Inventor: David Clayton Peister, Las Vegas, NV (US)

(21) Appl. No.: 14/061,752

(22) Filed: Oct. 23, 2013

Related U.S. Application Data
(60) Provisional application No. 61/717,150, filed on Oct. 23, 2012.

(51) Int. Cl. G06Q 40/06; G06F 17/18; G06Q 10/06

(52) U.S. Cl. CPC G06Q 40/06; G06F 17/18; G06Q 10/06375; G06Q 10/0635
USPC 705/7.28; 702/181; 705/7.37; 705/36 R

(57) ABSTRACT

The method proposed is an approach for creating, valuing and securitizing derivative instruments which are linked to a casino's or a basket of casinos' aggregate win rate. The invention has several components, all of which are facilitated by software: (1) a method for developing a risk profile for a given casino or a portfolio of casinos; (2) a method for estimating the optimal hedging strategy for a given casino based on level risk profile, maximum wagers at the table and required liquidity/corporate finance structure; (3) a method for estimating the expected value of variances in actual win rate to the threshold win rate; and (4) a method for developing the features required for securitizing an individual casino's or a portfolio of casino's derivative contracts.

### CROSS REFERENCE TO RELATED APPLICATIONS

This application claims priority from U.S. Patent Application Ser. No. 61/717,150, entitled “Method for creating and valuing derivative instruments which are linked to a casino's or a basket of casinos' win rate”, filed on 23 Oct. 2012. The benefit under 35 USC §119(e) of the United States provisional application is hereby claimed, and the aforementioned application is hereby incorporated herein by reference.

This application is related to U.S. Patent Application Ser. No. 61/511,029, entitled “Method for creating and valuing derivative instruments which are linked to a casino's or a basket of casinos' win rate”, filed on 23 Jul. 2011.

### FEDERALLY SPONSORED RESEARCH

Not Applicable

### SEQUENCE LISTING OR PROGRAM

Not Applicable

### TECHNICAL FIELD OF THE INVENTION

The present invention relates generally to casino risk management. More specifically, the present invention relates to creating, valuing and securitizing derivative instruments as related to casino risk management.

### DEFINITIONS

“Casino win” is the amount of a player's initial bankroll kept by the casino. Note that while, in theory, the player can win a limitless amount of money she can never lose more than her bankroll plus credit issued by the casino.

“Drop” is the sum of all the buy-ins.

“House advantage” (also known as “H.A.” or edge) is the statistical advantage programmed into games of chance which gives the casino an advantage over the player. H.A. is the percent casino should win on each wager or bet.

“Hands played” sometimes the referred to as decisions, bets or wagers this is un-weighted count of the unique rounds played made during the specified period on a specific game or set of games when there is a monetary wager on the outcome of the round. In general, volatility is governed by the number of unique decisions where decisions is denoted as N then square root of ∞N.

“House win” is the net difference of wagers taken at the table/cage and monies redeemed

“Non-negotiable chips” or “NNC” are special chips issued to VIP players, which can only be played and cannot be redeemed for cash. Casinos, unlike most industries, struggle to track transactions. Non-negotiable chips provides a simple mechanism for tracking a given players' actual play. When a player makes a wager and wins she is paid with live chips and keeps her NNC; when she loses she simply relinquishes her wagered NNC. When she plays through all her NNC's and only has live chips, she then cycles her live chips for NNC and continues play. This cycling process is termed ‘rolling’ in the industry and a player will ‘roll’ her live chips for non-negotiable chips. When NNC chips are used, player rebates are frequently assessed from NNC volume.

“Notional value” is the maximum amount of the payoff used to calculate the payoff value. In general, notional value will have a relationship to a volume measure like turnover or non-negotiable chip volume. In some instances, notional will be an arbitrary figure or otherwise capped.

“Payoff” is the amount paid to the buyer if the triggers occurs.

“Win rate” is defined as the casino win divided by turnover. Casino games, are programed to have a statistical house advantage for the house, often called house advantage. For the most popular of VIP games, baccarat, edge ranges from 1.06 percent to 14 percent increasing as the player takes increasing risky bets. Weighted average win rate at most properties with VIP baccarat action is on the 1.3 percent to 1.5 percent range. Win rate is often termed ‘edge’, ‘statistical advantage’, ‘house advantage’ or simple ‘H.A.’ in industry circles.

“Turnover” is the sum of all the wagers a player makes. For instance, if she bets five hands at $100 per hand then the turnover is $500.

“VIP players” is colloquial term for the largest segment of casino gamblers also called high-rollers and the largest players are often called whales.

### BACKGROUND OF THE INVENTION

Casino gaming is inherently risky even though the odds are weighted in the casino's favor. Casinos, which dabble in VIP gaming, are particularly vulnerable. This is because as more hands are played volatility naturally reduces; which is an application of the law-of-large numbers. VIP players are especially risky as they can win or lose a materially large sum over a small number of individual decisions. Win rate volatility is consequently more profound over the short-to-mid-term. Volatility erodes value by handicapping an operator's ability to fund operations, effectively market and can ultimately lead to balance sheet strain. Casinos often invest deeply in VIP gaming by procuring jets, building extravagant suites, and maintaining a deep branch office marketing structure. Several instances exist where a casino operator committed deep capital expenditures to the respective VIP business, only to abandon these investments when volatility becomes too onerous.

From a casino operator's perspective, a win rate hedge structure as a derivative product provides a potentially cost effective solution to one of the industries' thorniest issues. If a speculator purchases a casino win-rate derivative contract either from a market maker or from the secondary market, she is purchasing an investment, which does not correlate with any macro-market condition, which should yield a positive rate of return over the long-term.

Table gaming is a unique business in that no product is actually sold. Cash at the cage is the inventory and if the cage has more cash at the end of the day than at the start, then the casino had a good day and vice versa. As there is no real transactional exchange, tracking an individual player's worth is difficult. As a solution, casino use two major mechanisms to track a VIP player's worth: non-negotiable chips (popular in Europe, Australia and the US) and turnover (popular in Europe and the US). Non-negotiable chips are fast becoming the most popular method for tracking VIP table play worldwide as NNC's are easier to track, doesn't require a relationship with the patron and is much more accurate. Win rate on turnover, by contrast, is reliant on manual observation and often requires a relationship with the player. Most casinos with VIP business track either win rate on turnover or NNC win rate, but rarely both. The present invention works with either win rates although a slight modification is required for NNC win rate.

### SUMMARY OF THE INVENTION

Casino gambling is, by design, a risky business. While the odds are stacked in the house's favor, casinos often lose to their largest/VIP table players over the short-to-mid-term. This phenomenon is known as win rate volatility. The method proposed is an approach for creating, valuing and/or securitizing derivative instruments which are linked to a casino's or a basket of casinos' aggregate win rate. The invention has several components, all of which are facilitated by software: (1) a method for developing a risk profile for a given casino or a portfolio of casinos; (2) a method for estimating the optimal hedging strategy for a given casino based on level risk profile, maximum wagers at the table and required liquidity/corporate finance structure; (3) a method for estimating the expected value of variances in actual win rate to the threshold win rate after incorporating the intrinsic elasticity between win rates and wager volumes; and (4) a method for developing the features required for securitizing an individual casino's or a portfolio of casino's derivative contracts.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 illustrates the results of a Monte Carlo simulation for a large player;

FIG. 2 is an illustrative derivative contract for a casino;

FIG. 3 is a flow chart illustrating a simplified process of a casino purchasing a derivative product and a market maker selling the derivative as a financial product;

FIG. 4 is an illustrative derivative contract purchased by a casino in one exemplary embodiment of the present invention;

FIG. 5 illustrates the modeling of the casino's cash-flow scenarios from the exemplary embodiment of the present invention;

FIG. 6 is a chart illustrating the material risk of the exemplary embodiment cannot be properly modeled with a normal/Gaussian curve when house win results are skewed by player bankroll

FIG. 7 is a chart illustrating the actual risk of the exemplary embodiment of the present invention can be estimated more accurately with a probability distribution which can accommodate parameters related to shape and skew;

FIG. 8 is a chart illustrating the probability that a given trigger will occur in light of the number of hands wager;

FIG. 9 is a chart illustrating that hedging with derivatives can be a more efficient corporate liquidity strategy than debt or equity financing;

FIG. 10 is a Monte Carlo simulation illustrating that the derivative hedge is not only a down-side avoidance strategy but also allows the casino to grow revenues;

FIG. 11 is a flow chart illustrating a system for creating VIP win rate linked derivatives;

FIG. 12 is a schematic view of the process for calculating the risk profile for a prospective reference casino or basket of casino win rate;

FIG. 13 is a schematic view of the process for calculating expected value of the variances;

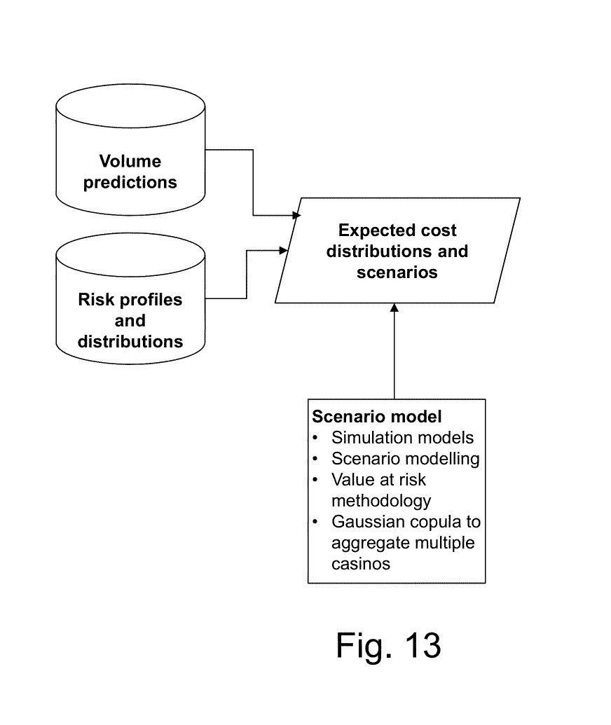

FIG. 14 is a schematic view for determining the optimal hedging strategy;

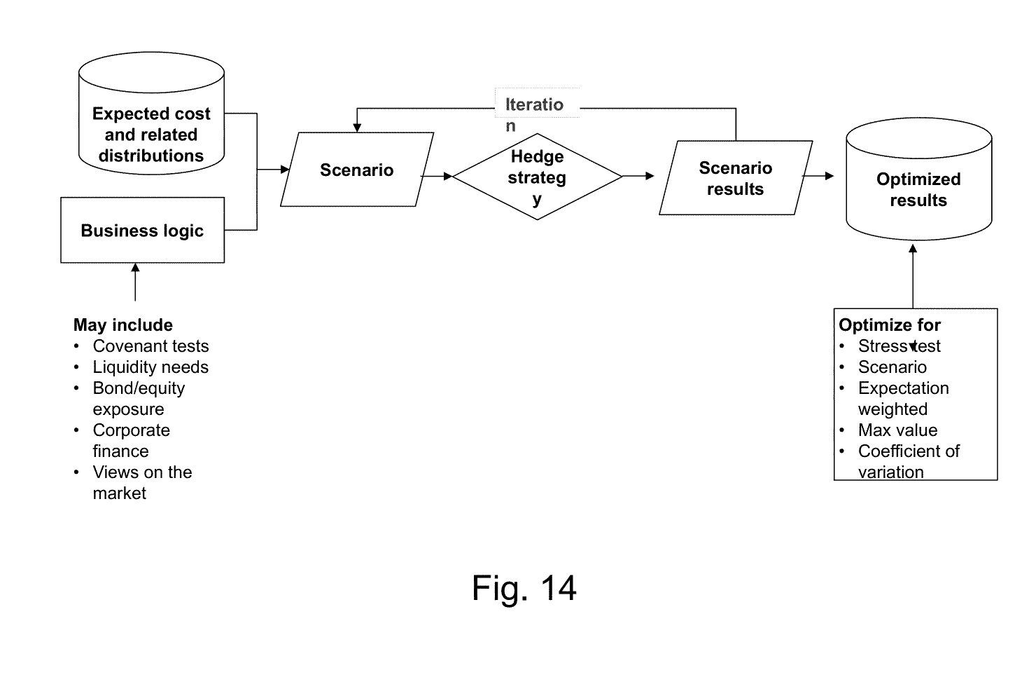

FIG. 15 illustrates the process for designing the features required for specifying the final terms of the derivative and terms required for securitization; and

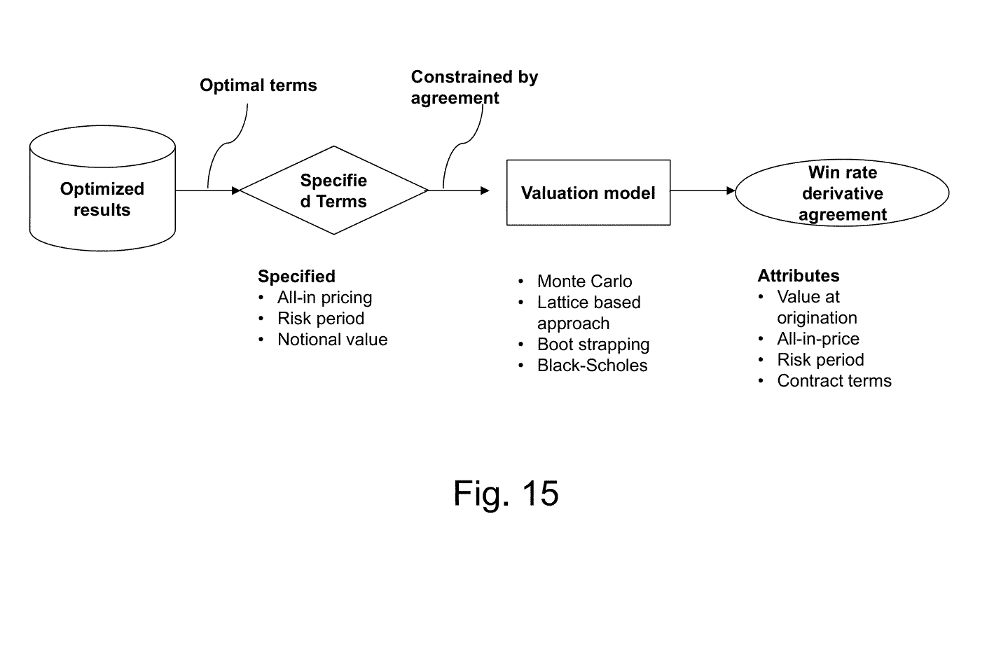

FIG. 16 is a flow chart illustrating the structure for derivatives.

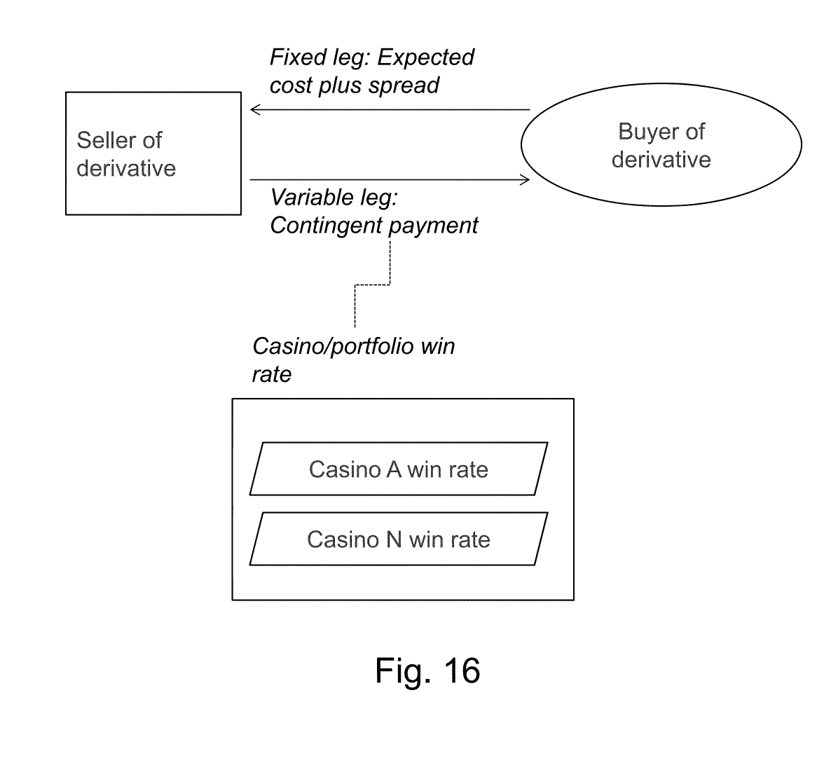

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The physical apparatus required to enable one embodiment of the present invention includes a web server; a web portal interface; a multi-user network; databases; and an application server. Thus, the method of the present invention may also be recorded onto a CD, or any other recordable medium as well as being delivered electronically from a database to a computer, wherein the method embodied by the software that is recorded is then executed by a computer for use and transformation of the Internet browser and its contents. Now referring to the Figures, the embodiment of the method of the present invention is shown.

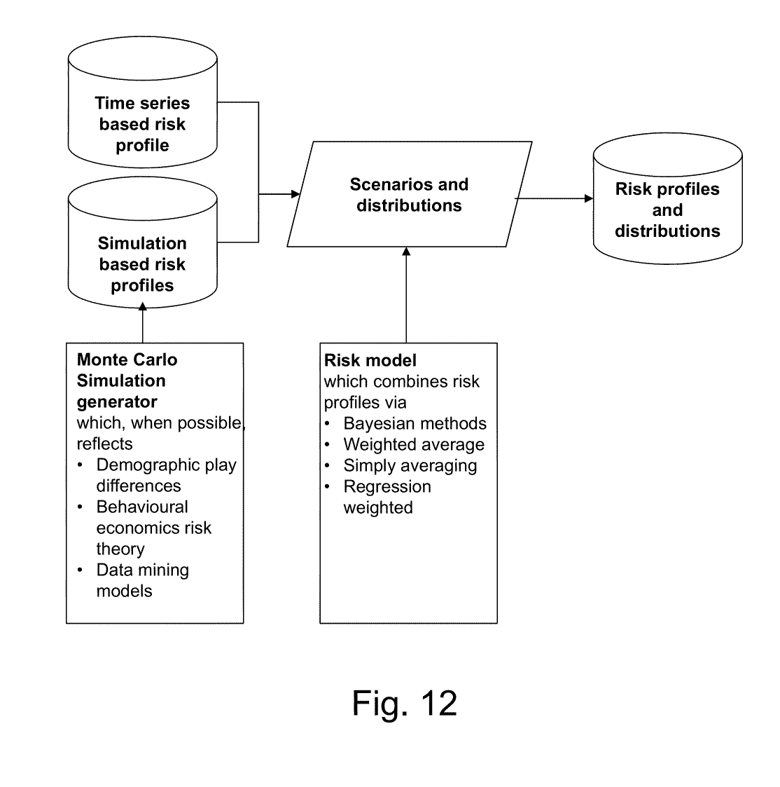

The casino win rate derivative (also referred to as “WRD”) is simply a contract whereby the seller agrees to pay the buyer a monetary value, calculated in a prescribed fashion, linked to a casino's or a portfolio of casino's win rate for a specific period of time in exchange for a fixed payment as illustrated in FIG. 12.

Referring to FIG. 12, the derivative has two parties: the seller and the buyer. The relationship is the seller of the instrument pays the buyer of the instrument in the instance that a specific trigger occurs (known as the variable leg) the buyer of the instrument pays the seller a fixed amount (known as the fixed leg).

More broadly, we can succinctly categorize the parties to a WRD as either a hedger or a speculator. As a derivative instrument, neither party needs to have direct economic exposure to the reference win rate. In practice, it is expected that the hedger will normally have direct economic exposure to a casino's win-rate downside volatility. By contrast, a speculator is less likely to have any direct exposure to the underlying casino's win-rate downside volatility and is instead looking for an asset class. Speculators might include arbitrators as this type of derivative is easily handicapped for valuation inefficiencies. As a unique asset class, WRD contracts are unique in that the returns are truly random and not definition not correlated to any macro-economic trend. Consequently, speculators with an appropriate balance sheet are very likely to see positive returns over the long run.

When the actual win rate is below the strike threshold win rate then the variable leg payoff is triggered and the buyer receives the agreed to payoff. So if S is the strike win rate and W is the actual win rate for a period the derivative is ‘in the money’ for the buyer if S>W. In the case of a swap configuration, if S<W then counter party A receives a payoff whereas if S>W then counter party B receives a payoff.

Notional value can be defined and calculated in several ways, as outlined below
1. Actual turnover or non-negotiable chip volume
2. Actual turnover or non-negotiable chip volume subject to a specified cap
3. An arbitrary value which reflects either parties which fits the parties underlying view or strategy

The WRD payoff is structured in one of three basic forms: variance, digital or swap although the WRD can also be constructed into an option, akin to a swaption.

For a vanilla variance type WRD the payoff is calculated as the prorated variance between the actual win rate and the strike win rate. If S=strike win rate; W=actual win rate; and N=notional or face value, then the payoff is calculated as the absolute value of either maximum of either (W-S)*N or 0 and by definition the payoff is triggered when S>W.

Alternatively, the WRD can specify a binary or digital payoff. In this instance, the face value is paid in its entirety when S>W.

The WRD can also be structured as a swap in one of two ways. In a true swap format the positive and negative variance is swapped whereby counterparty A pays counterparty B the variance the negative variance between S-W and counterparty B pays counterparty A the positive variance between S-W. And alternate swap structure might specify that counterparty A pays counterparty B the S*N and counterparty B pays counterparty B pays counterparty A W*N.

The payoff can be structured to accommodate option like features as well as caps and collars. The derivative can also be configured to accommodate collars, caps or floors or forward/future contracts, which is linked to the trading spread of the underlying derivative and alters the payoff calculation.

Actual win rate (W) is defined as the actual win rate (either NNC or on turnover) for a single property, a corporation or the aggregate win rate for a specified portfolio of properties. In the case of the latter calculated as the weighted-average win rate across the portfolio where the weighting is a predetermined function—most commonly volume weighted by either total NNC, total turnover, or a blend thereof.

The derivative has a definitive start and end date and the payoff is evaluated at the end for the actual win rate occurring during the specified period, also referred to as the risk period.

A fixed leg payment occurs when the buyer pays the seller a specified sum for the WRD, which may be paid incrementally during the life of the WRD, as an initial upfront payment or at the end of the derivative's risk period. In the case of the latter, payment netting may be involved. If the derivative is a swap format, the payment is generally floating rather than fixed. Generally, it is expected that the payment is the expected cost of the payoff plus a basis point spread. In addition, the payment may include transactional costs.

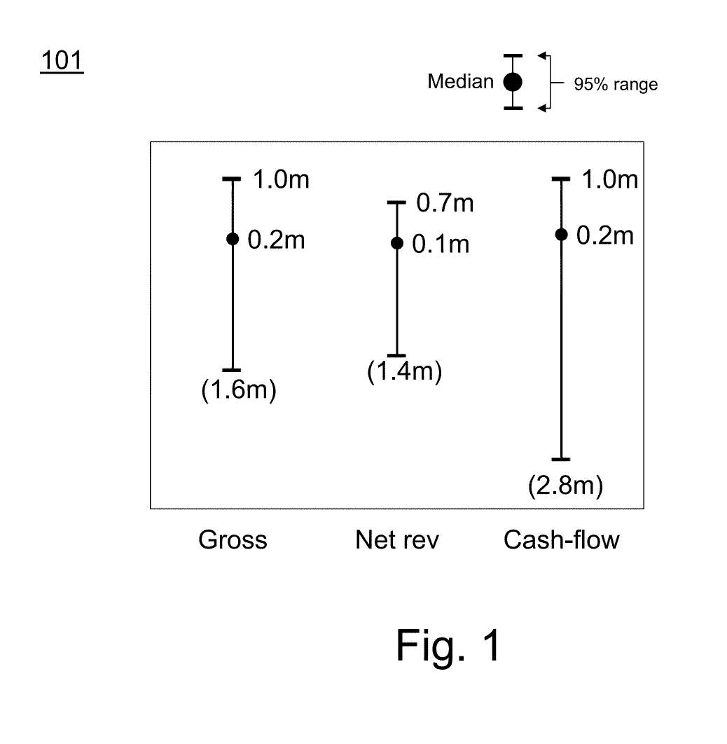

Now referring to the Figures, an exemplary embodiment of the present invention is illustrated. A fictitious casino is considering whether to accept the action of a large player/patron. The patron wants to bring in $500 k front money and borrow $500 k for a three day stay. The casino expects her to bet $22K on average and the casino has extended to her a 25 percent discount on loss promotional program. On average a casino win (i.e. ‘hold’) or keep 14-18 percent of a patron's bankroll. (Note that Hold is a derivative of edge where hold is equivalent to win over the patrons buy-in.) But there is a huge band around hold. Many casinos have a hold standard deviation which is six times larger than hold itself. Credit risk averages 1-4 percent of a win. In this example, a one million dollar player can become a three million dollar liability for the casino. Based on an 18 percent average hold and 108 percent standard deviation, then, only four percent of patrons will actually have a hold between 15 & 25 percent. In fact, 43 percent of patrons will actually win from the casino. If taxes, bad debt, and a rebate are added in, then five percent of the time the casino will lose $2.8 m on this $1 m player as shown in FIG. 1.

The problem is rarely the impact of one large player but rather the scores of players like the large patron who regularly play. For example, the risk profile changes dramatically if there are 30 large players compared to one. With thirty large players having an average bet of 22 thousand dollars playing roughly 11 thousand hands and a table differential (de facto max bet) is 360 thousand dollars which represents 242 million in bets across the tables.

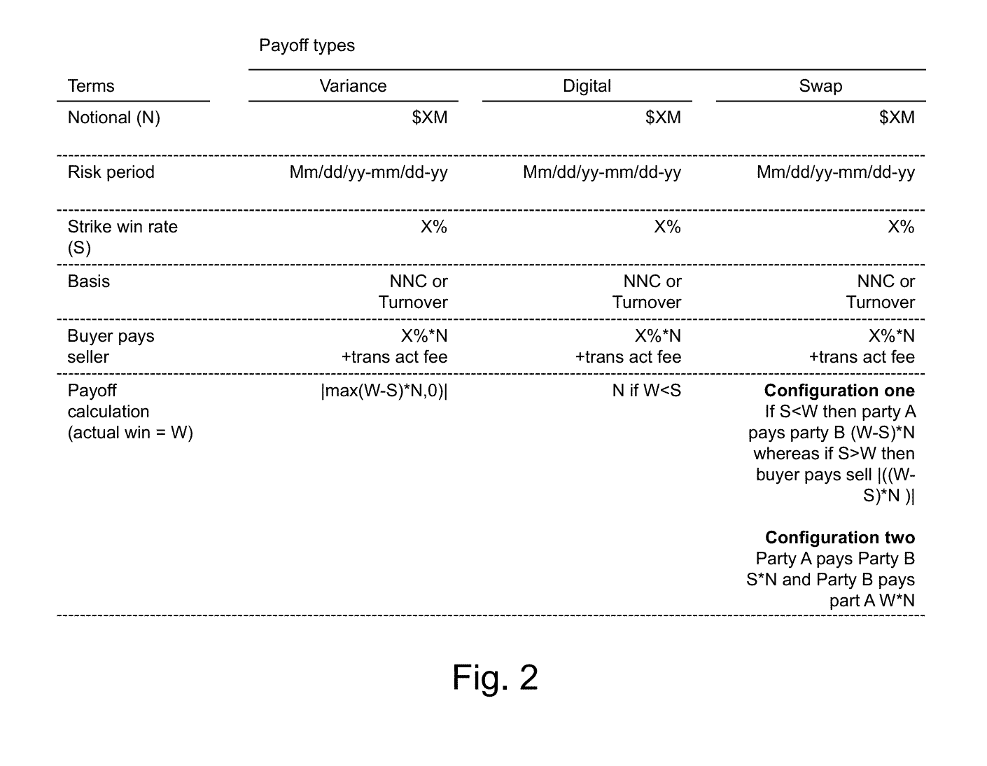

One solution is a financial product—a derivative—which can act as an artificial risk transfer mechanism if a casino win is below a hurdle as shown in FIG. 2. The seller pays the buyer either the face value, or a prorated portion thereof, if the related casino win is less than this value. The term length can be set to any timeframe as desired. The buyer can tailor the derivative features to reflect the expected property performance for the specified timeframe.

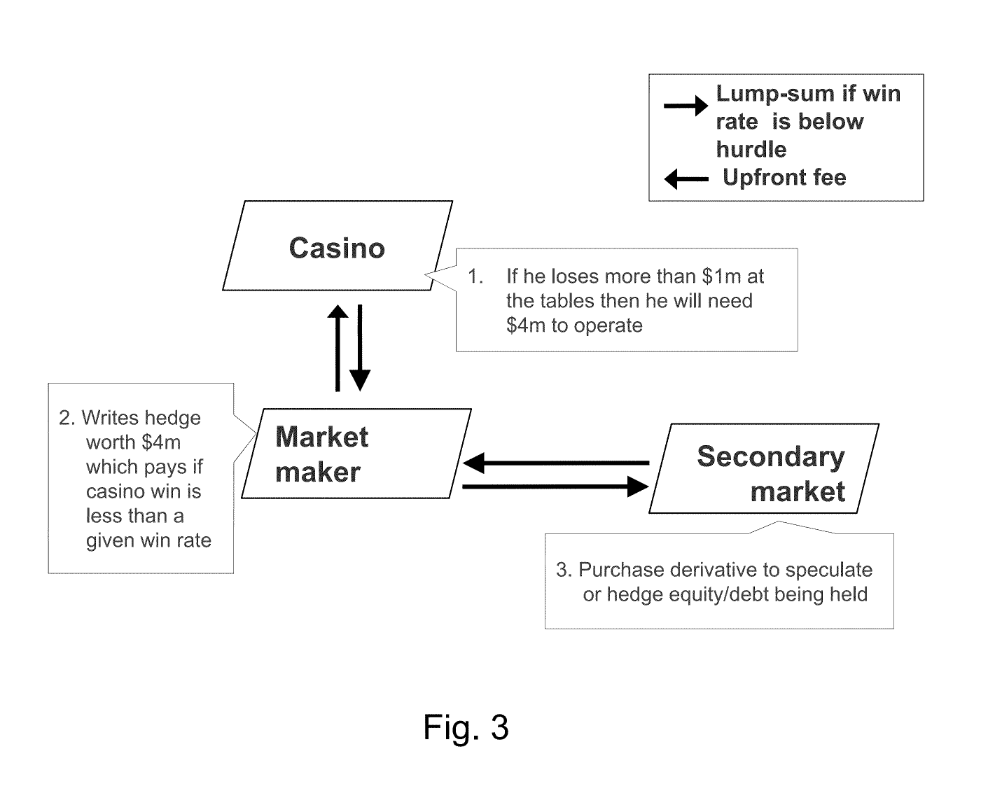

Continuing with the ficticous example, the hedger would purchase the derivative in the amount of four million for a spread above risk and the market maker can then re-sell to financial market as illustrated in FIG. 3.

Multiple derivative contracts covering a portfolio of properties can be bundled into a financial product which can then be securitized. A financial product which is a portfolio of casino win hedges is easily bundled based geographic origin; based on the cumulative hands played, this product is largely self-hedging; should be relatively low-risk; and the product has the advantage of not being correlated with any underlying macro forces.

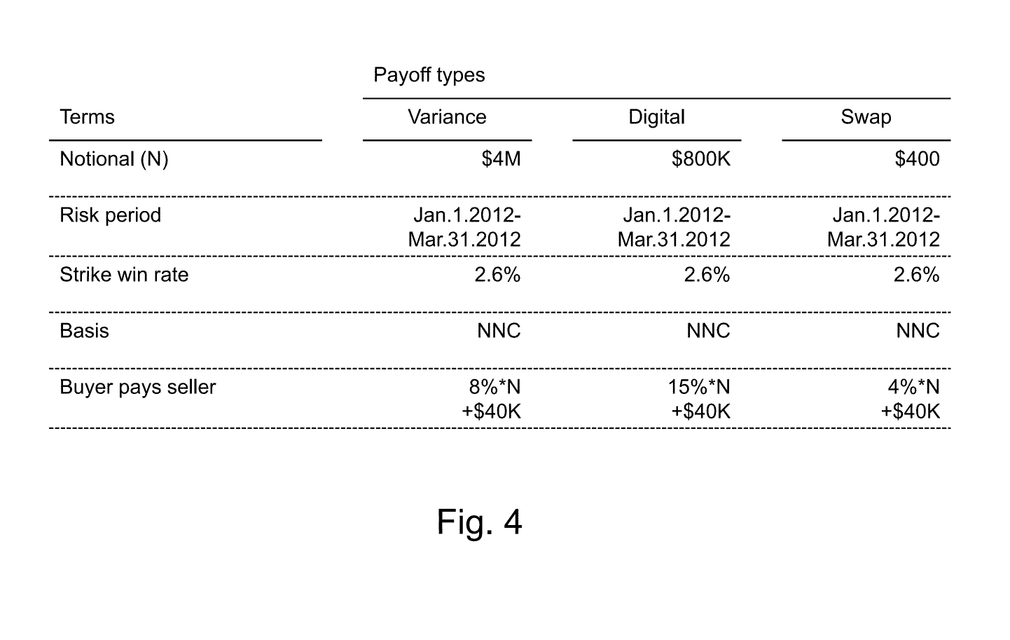

Now referring to FIG. 4, based on the forecast of thirty high-end players, the casino buys the derivative hedge as illustrated. In this example, if the actual win rate is 2.5 percent versus a strike win rate of 2.6 percent for a ninety-day period and in light of the specified performance terms then the following is true: for a variance style WRD the seller pays the buyer $800K on a derivative which costs eight percent of notional value; for a digital WRD the seller pays the buyer $800K on a derivative which costs 15% face value; and while for a swap-style WRD the seller pays the buyer $800K on a derivative which costs four percent of notional value.

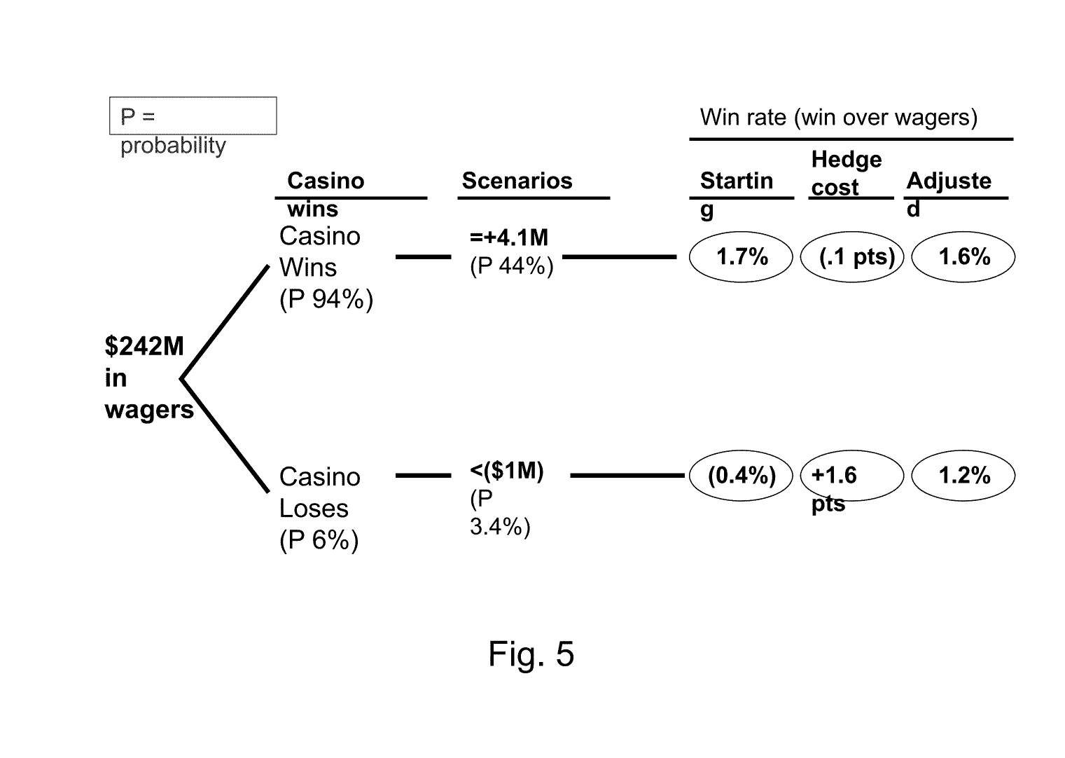

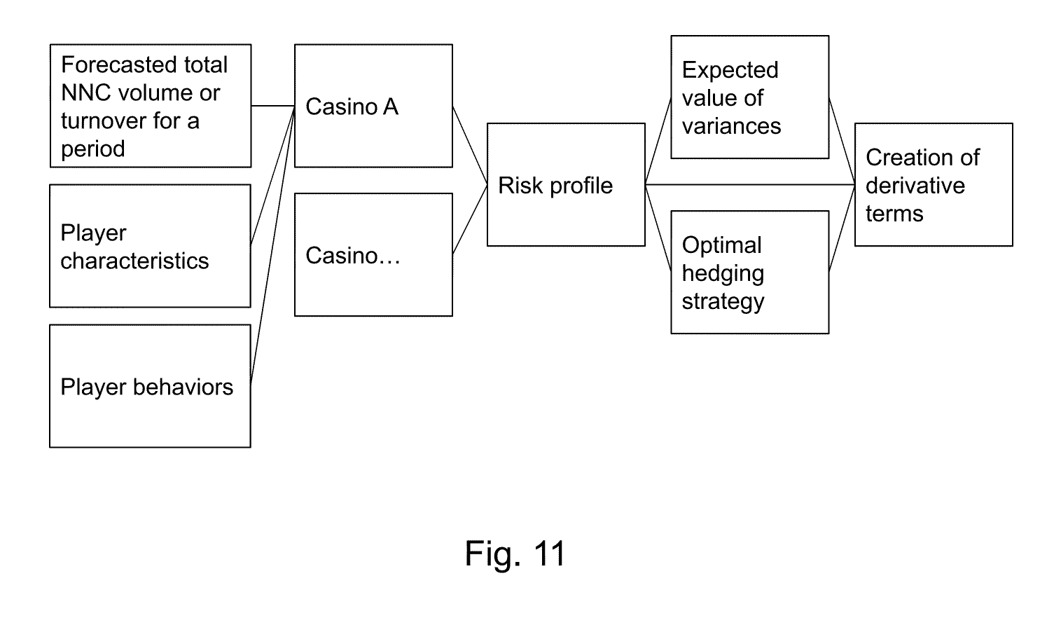

An example of the type of probability cash-flow modeling is illustrated in FIG. 5. In this example, the hedging cost is translated into an adjusted win rate. FIG. 11 illustrates a system for creating VIP win rate linked derivatives. A casino considers forecasted total NNC volume or turnover for a period, a player's characteristics, and a player's behavior to create a risk profile. More specifically, the ‘risk profile’ has the following features: probability distribution of actual house win scenarios which are appropriately volume weighted; standard descriptions of this distribution like mean, median, standard deviation, kurtosis, skew, range, etc. From the risk profile the expected value of the strike win rate and notional value are determined and an optimal hedging strategy is developed. The expected value of the strike win rate and notional value and optimal hedging strategy are then combined to create a creation of derivative terms.

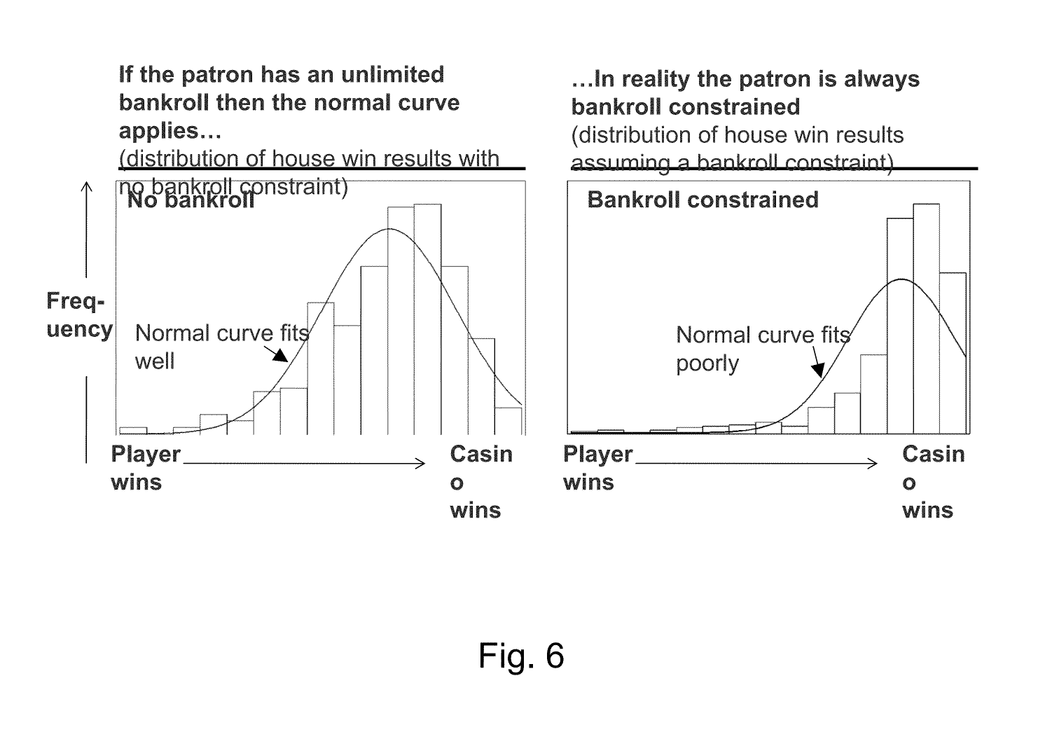

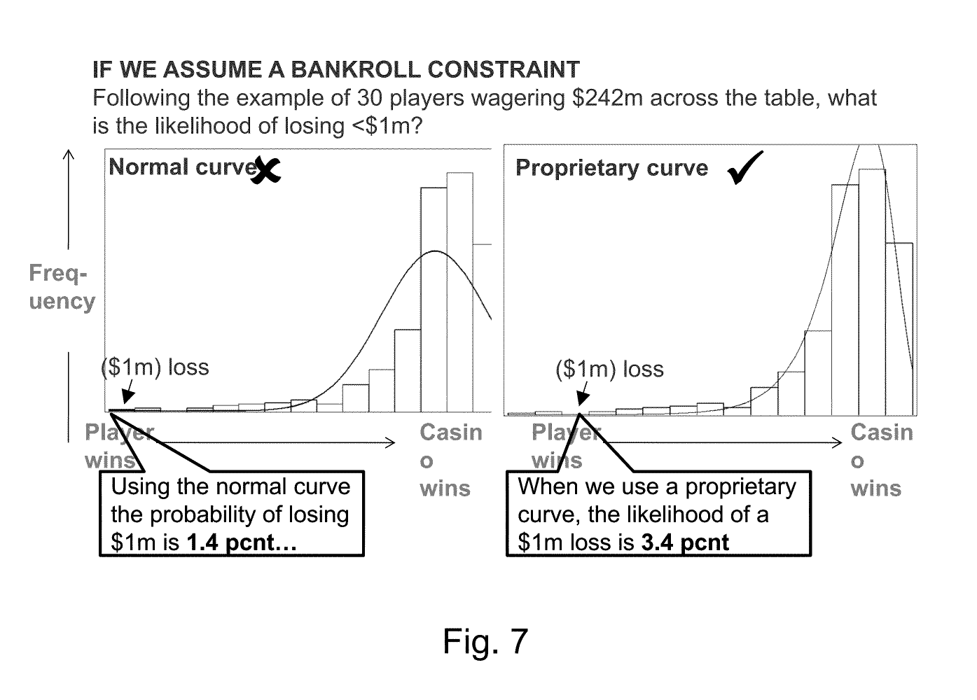

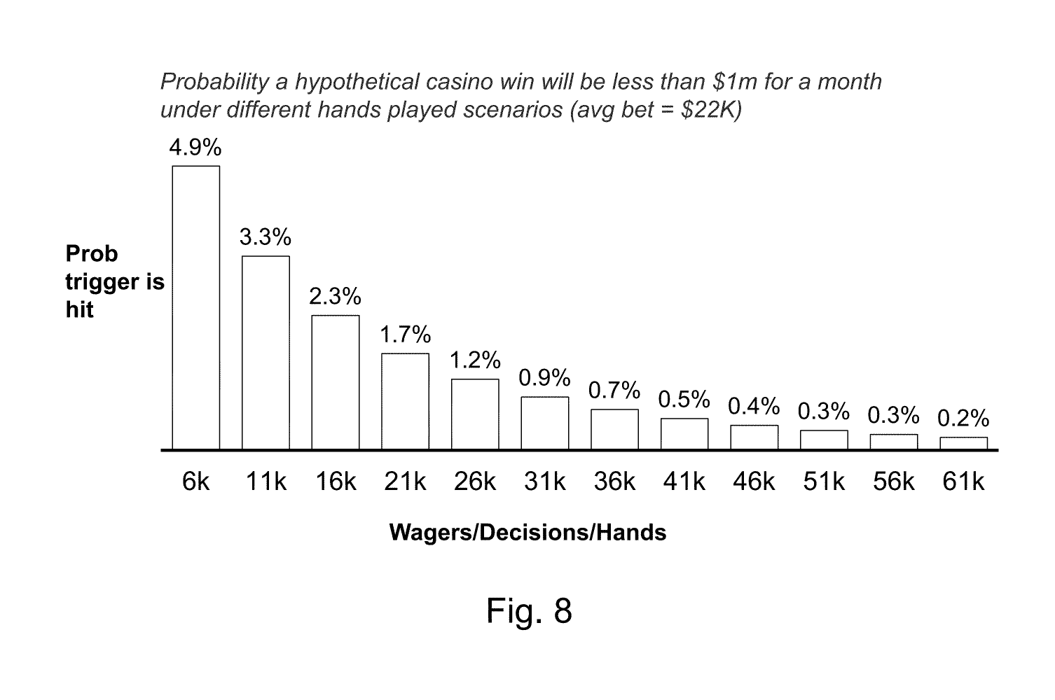

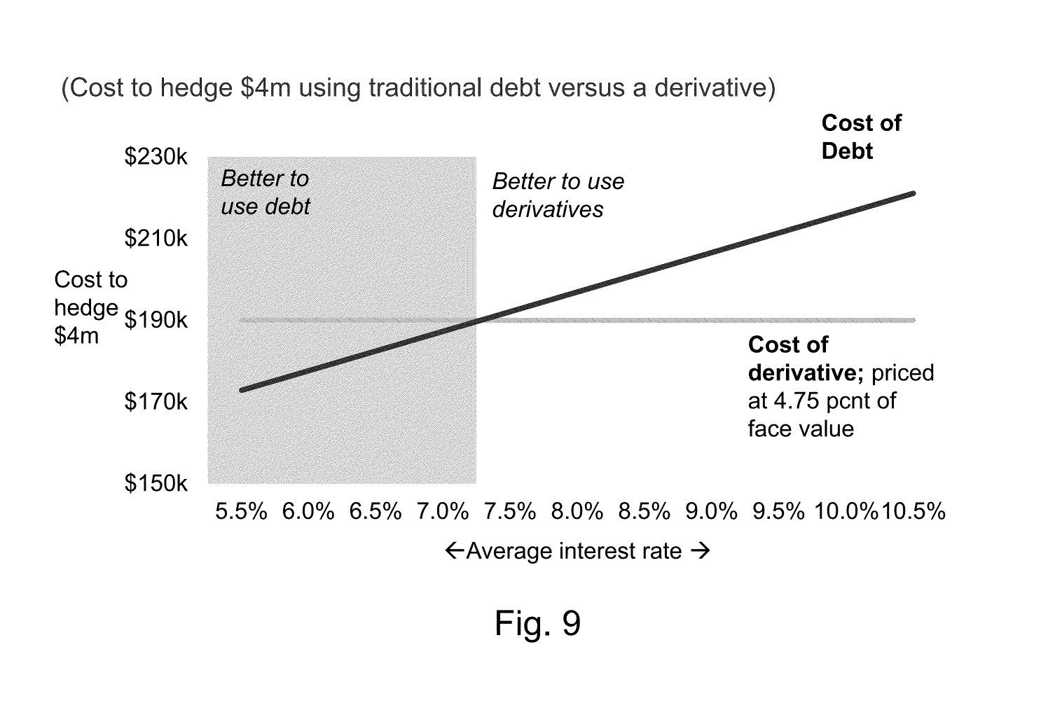

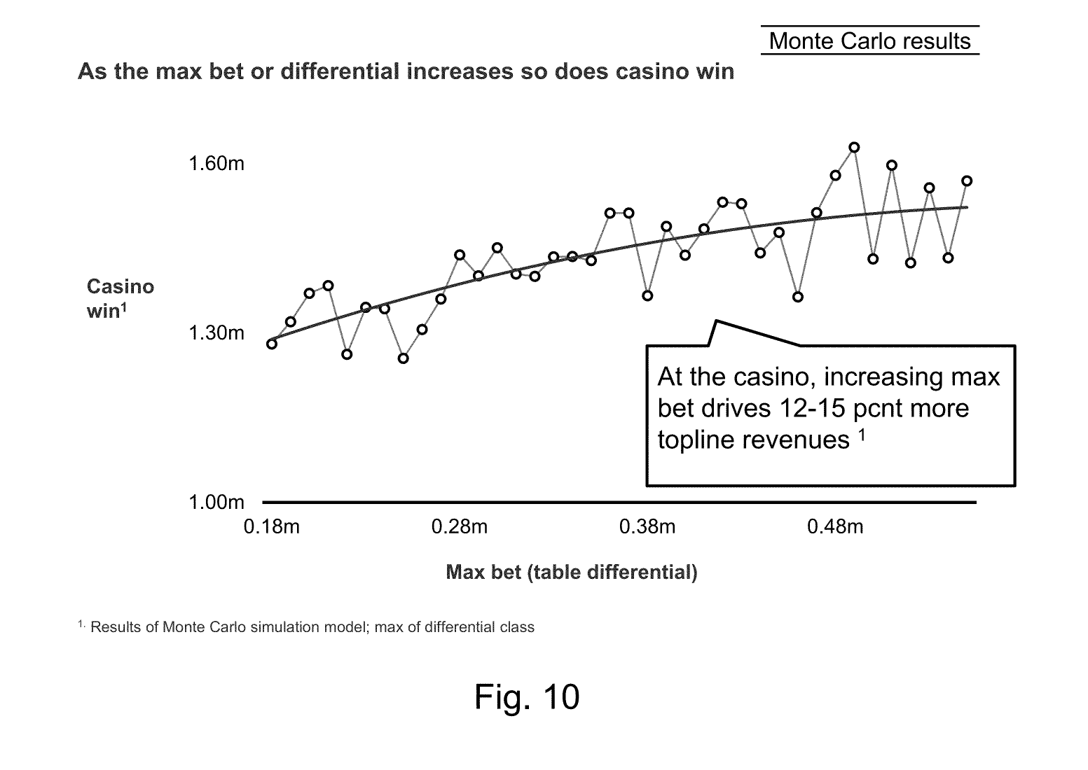

If the player has a bankroll constraint, then the normal curve understates risk materially as shown in FIG. 6. The actual risk can be estimated much more accurately with a probability distribution that accommodate a skewed distribution and approach as shown in FIG. 7. If the casino's derivative is triggered when a win rate is less than 2.6 percent, then what is the probability trigger will occur? In the case of digital payoff, this probability is the minimum the hedge can be priced as shown in FIG. 8. In the case of a variance style payoff or a swap style payoff, the minimum cost of the hedge is the downside weighted average of house win. Hedging with derivatives will always be more cost effective when borrowing costs are high, which is a common case in gaming and illustrated in FIG. 9. The derivative hedge is not only a down-side avoidance strategy but also allows the casino to grow revenues as shown in the Monte Carlo simulation results illustrated in FIG. 10.

The method taught by the present invention is set to run and/or executed on one or more computing devices. A computing device on which the present invention can run would be comprised of a CPU, hard disk drive, keyboard or other input means, monitor or other display means, CPU main memory or cloud memory, and a portion of main memory where the system resides and executes. Any general-purpose computer, tablet, smartphone, or equivalent device with an appropriate amount of storage space, display, and input is suitable for this purpose. Computer devices like this are well known in the art and are not pertinent to the invention.

In alternative embodiments, the method of the present invention can also be written or fixed in a number of different computer languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for estimating the likelihood and value of variances in actual win rate from the theoretical win rate over an electronic medium, comprising the steps of:
a. calculating an expected win rate using an probabilistic approach or a simulation whereby the following variables may be used:
b. calculating the expected win rate based on the product of the preceding step and the estimated turnover or NNC volume of wagers;
c. creating a non-linear adjustment for the elastic relationship between win rate and turnover;
d. calculating a variance and standard deviation;
e. calculating a probability distribution either analytically or via a simulation using the byproducts of steps a through d; and
f. using these data or the probability distribution from step d to calculate the likelihood and magnitude of a casino's win rate variance from the expected average (P).

2. The method of claim 1, wherein the calculated expected win rate includes one or more of the following: mix of game types, mix of even-money bets to propositional wagers, average bankroll, table maximums/differential, average bet, game speed, length-of-play, betting style, historical results and availability of credit.

3. The method of claim 1, wherein the variance and standard deviation includes one or more of the following: of game types, mix of even-money bets to propositional wagers, average bankroll, table maximums/differential, average bet, historical results, game speed, length-of-play, betting style, and availability of credit.

4. The method of claim 1, wherein the likelihood of the trigger occurring as calculated in step e is the basis for estimating the expected cost of a given notional value for the WRD.

5. The method of claim 1, wherein step f is estimated via a simulation model, mathematically, or probabilistically with means of a probability distribution.

6. The method of claim 5, wherein in the case of a probability distribution, this likelihood is modeled with a Johnson family distribution, Gumbel distributions, or when there is sufficient hands/decisions with a Normal curve.

7. A method for estimating the optimal hedging strategy for a given casino, comprising the steps of:
a. calculating the downside casino win-risk scenarios and probability via a Monte Carlo simulation approach by specifying ranges for player betting propensities, player behavior, player's hypothesized view on risk and return as described in behavioral economic theory, aggregate NNC or turnover volume, individual player bankroll;
b. estimating the impact of alternative maximum wager/table differential on step a; and
c. solving for optimal hedging structure in light of step one, step two and a casino company's corporate finance structure, liquidity needs, debt rating, or management's expectations.

8. The method of claim 5, wherein optimal structure is estimated via a simulation approach, linear programming, or non-linear optimization.

9. A method for developing a risk profile for a given casino or a portfolio of casinos, comprising the steps of:
calculating a forecasted demand for a given period;
modeling the impact of variations in player betting styles and player demand;
modeling the impact of variations in mix of wagers across a specific game type;
modeling the impact of variations in mix of wagers across even-money bets and propositional bets;
incorporating players views on risky outcomes utilizing data-mining, prospect theory and other behavioral economic theory;
modeling the impact of variations in game speed;
modeling the impact of variations in wager size;
modeling the impact of variations play hours;
assuming constraints in wager by chip denominations;
assuming skewed distribution of outcomes biased by individual bankroll constraints and the availability of casino credit;
developing specific risk measures including value-at-risk and probability of casino win scenarios for a specific period by means of either simulation or via a combinatorial approach; and
modeling the elastic relationship between variations in win versus the underlying theoretical win rate and the player's volume of wagers.

10. A method for developing the features required for securitizing an individual casino's or a portfolio of casino's derivative contracts, comprising the steps of:
determining a the hedger's/speculator's desired hedge position;
considering the underlying casino's/portfolio of casino's risk profile;
reflecting the hedger's/speculator's desired timeframe;
including any constraints by any prevailing regulatory body or legal precedent;
determining the characteristics, features, and mechanics for either a call or a put derivative

11. The method of claim 10, wherein the mechanics for either a call or a put derivative are: a swap, swaption, or option linked to the underlying casino's/portfolio of casino's relevant win rate.

12. The method of claim 11, wherein the characteristics, features, and mechanics include:
underlying casino or portfolio of casinos, strike win rate, notional value/face value, timeframe, weightings, price/cash-flow exchange, premium, minimum operator performance, restrictions and responsibilities for assignment, and unwinding and transactional costs.

13. The method of claim 10, further comprising the steps of
communicating the derivative to the counter-party electronically and held by the counter-party or traded, either OTC or on an exchange; and
determining the value by mark-to-market accounting and price set by the market if the counter-party decides to trade this WRD then value.

14. The method of claim 13, wherein the WRD is configured as a plain vanilla variant.

15. The method of claim 13, wherein the WRD is configured as an exotic options or combination thereof.

16. The method of claim 13, wherein the WRD feature a variety of embedded options or multiple triggers.

17. The method of claim 13, wherein in the case that the derivative is a bundle of multiple casinos' win rates hedges, then the expected cost and likelihood is modeled via a Guassian Copula approach.
